(19) United States
(12) Patent Application Publication
(10) Pub. No.: US 2008/0228848 A1
(43) Pub. Date: Sep. 18, 2008

(54) Data Processing Device and Data Processing Method

(76) Inventor: Kenji Takahashi, Osaka (JP)

Correspondence Address: MARK D. SARALINO (MEI);RENNER, OTTO, BOISSELLE & SKLAR, LLP, 1621 EUCLID AVENUE, 19TH FLOOR, CLEVELAND, OH, 44115, US

(21) Appl. No.: 10/597,446

(22) PCT Filed: Jan. 26, 2005
(86) PCT No.: PCT/JP2005/000986

§ 371 Date: Jul. 26, 2006

(30) Foreign Application Priority Data
Jan. 29, 2004 (JP) 2004-021069

(51) Int. Cl. G06F 15/16

(52) U.S. Cl. 709/201

(57) ABSTRACT

To get playback and editing done without troublesome operations even if program(s) to edit is/are separately saved on the storage media of multiple data processors.

A data processor can exchange data with a device, which is connected to a network and uniquely identifiable in the network by its own device information. The processor includes: a processing section for generating content data and identification information to uniquely identify each content and getting them stored on a storage medium; a network control section for establishing a connection with the network and sending out the device information and the identification information in response to a request from the device; another processing section for generating a management table, in which if at least one content has been designated by the device as a content to play back in the one or more contents, the identification information of the at least one content is associated with the device information of the device; and a storage section for storing the management table.

### TECHNICAL FIELD

The present invention relates to a technique of playing back one or more contents that is/are stored in a plurality of data processors.

### BACKGROUND ART

A recorder/player such as a DVD recorder has the function of editing content data (e.g., data about a recorded TV program). As used herein, the “editing” refers to deleting or splitting part or all of content data, for example.

Examples of other editing operations include making, changing and deleting a playlist (which will be referred to herein as “playlist editing” collectively). A playlist is a list that defines the order in which some or full interval of one or more contents should be played back. Each interval is defined by the user who sets a playback start point and a playback end point. If the content(s) is/are played back following the playlist, multiple programs or parts of a program can be played back seamlessly as if those programs or those parts formed a single continuous program. As for technologies concerning playlist, see Patent Document No. 1, for example. By copying (or dubbing) and merging together necessary content data in accordance with the playlist produced, a single program can be newly created, too.

Patent Document No. 1: Japanese Patent Application Laid-Open Publication No. 2000-322878

### DISCLOSURE OF INVENTION

### Problems to be Solved by the Invention

A conventional recorders/player, however, does not allow the user to edit the content data in question unless the data is saved on the storage medium (e.g., a hard disk) in that recorder/player itself. That is why if the content data to be subjected to playlist editing is separately saved on the storage media of multiple recorders/players, for example, then the content data needs to be dubbed onto a single removable medium so as to be readily edited or played back by a single recorder/player. This is a very troublesome for the user. Particularly if the content data had such a big size as to exceed the maximum storage capacity of that removable medium, then editing would be impossible unless a storage medium with a big storage capacity such as a hard disk is used.

An object of the present invention is to get playback and editing done without any need for troublesome operations even if program(s) to be subjected to playlist editing or any other editing operation is/are separately saved on the storage media of multiple recorders/players.

### Means for Solving the Problems

A data processor according to the present invention is capable of exchanging data with a device that is connected to a network. The device is uniquely identifiable in the network by its own device information. The data processor includes: a processing section for generating content data about one or more contents and identification information to uniquely identify each of the one or more contents and getting the content data and the identification information stored on a storage medium; a network control section for establishing a connection with the network and sending out the device information and the identification information in response to a request from the device; another processing section for generating a management table, in which if at least one content has been designated by the device as a content to play back in the one or more contents, the identification information of the at least one content is associated with the device information of the device; and a storage section for storing the management table.

The processing section may generate the management table by further associating interval information, which specifies a playback interval of the at least one content, with the content.

The processing section may specify the playback interval based on the presentation times of the at least one content.

The processing section may generate the management table by getting the identification information of a non-designated content, which is not designated as a content to play back in the one or more contents, included on the management table and by further associating information showing identity as a content to play back with the identification information of the at least one content that is designated as the content to play back.

Two or more devices may be connected to the network. The network control section may receive an editing instruction on how to edit the content data and identification information to identify a content to be edited from a predetermined one of the devices. And the processing section may permit the content data editing if the processing section has determined based on the identification information received and the device information of the predetermined device that the content to be edited is designated as a content to be played only by the predetermined device.

The network control section may receive an editing instruction to delete the content data, and the processing section may permit the content data deleting if the processing section has determined that the content to be edited is designated as the content to be played only by the predetermined device.

The processing section may delete the content data and remove the identification information about the deleted content data from the management table.

The processing section may prohibit the content data editing if the processing section has determined that the content to be edited is designated as a content to be played back by a device other than the predetermined device.

The network control section may output a request to remove the content to be edited from the list of contents to play back to the device other than the predetermined device.

A data processing method according to the present invention is carried out by a data processor capable of exchanging data with a device that is connected to a network. The device is uniquely identifiable in the network by its own device information. The method includes the steps of: generating content data about one or more contents and identification information to uniquely identify each of the one or more contents; getting the content data and the identification information stored on a storage medium; establishing a connection with the network and sending out the device information and the identification information in response to a request from the device; receiving a designation, which designates at least one content as a content to play back in the one or more contents, from the device; and generating a management table on which the identification information of the at least one content is associated with the device information of the device.

### Effects of the Invention

According to the present invention, playlist editing can be done more easily on a plurality of contents that are separately saved on multiple recorders/players.

In addition, according to the present invention, the same content is never edited by multiple recorders/players at the same time, thus causing no inconveniences during the playback.

### BRIEF DESCRIPTION OF DRAWINGS

FIG. 1 illustrates a configuration for a recorder/player system according to a first specific preferred embodiment of the present invention.

FIG. 2 shows an arrangement of functional blocks in the recorder 101.

FIG. 3 shows a data structure for an MPEG2 program stream 50 compliant with the DVD Video Recording standard.

FIG. 4 shows the data structure of a video pack in the program stream 50.

FIG. 5 shows the procedure of a playback operation being performed using the playlist shown in Table 1.

FIG. 6 shows a simplified configuration for the recorders 101 to 103.

Portions (a) through (c) of FIG. 7 show how the management table of Recorder A changes.

FIG. 8 is a flowchart showing the procedure of processing to be done by Recorder A.

FIG. 9 shows a management table for Recorder A on which the name of a designator recorder is associated with the selected range on a playlist.

FIG. 10 shows a configuration for a recorder/player system according to a second specific preferred embodiment of the present invention.

FIG. 11 shows an exemplary management table according to the second preferred embodiment.

FIG. 12 is a flowchart showing how locking means performs lock setting processing.

FIG. 13 is a flowchart showing how the locking means performs unlocking processing.

FIG. 14 is a flowchart showing the procedure of processing to be done by the locking means during an editing operation.

FIG. 15 is a flowchart showing the detailed procedure of the editing process.

### DESCRIPTION OF REFERENCE NUMERALS

100 recorder/player system
101 to 103 recorder
104 TV
105 network
106 remote controller
205 DVD
11A, 11B, 11C drive apparatus
12A, 12B, 12C network connecting means
13A, 13B, 13C device operating means
14A, 14B, 14C storage means
15A, 15B, 15C management table
16A, 16B, 16C locking means

### BEST MODE FOR CARRYING OUT THE INVENTION

Hereinafter, preferred embodiments of the present invention will be described with reference to the accompanying drawings. In the following description of preferred embodiments, a recorder/player (data processor) for recording and/or playing a content will be simply referred to herein as a “recorder”.

### Embodiment 1

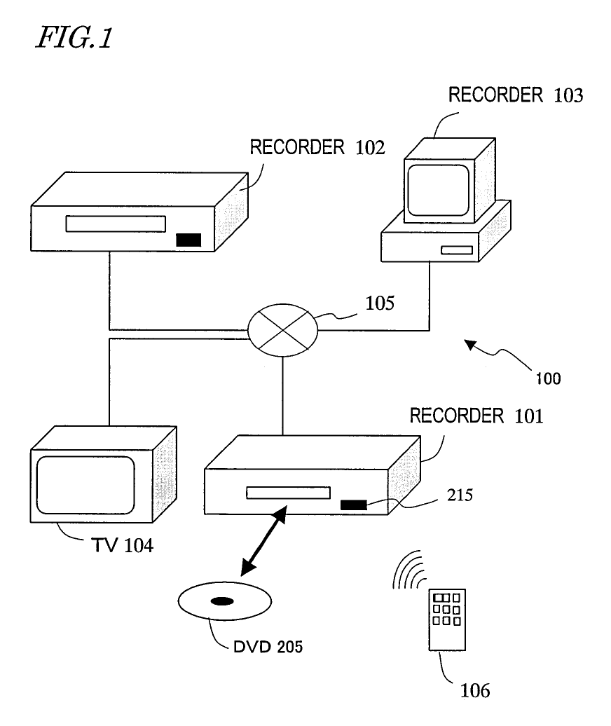

FIG. 1 illustrates a configuration for a recorder/player system 100 according to a first specific preferred embodiment of the present invention. The recorder/player system 100 includes a number of recorders 101 to 103 and a TV 104, all of which are connected together over a network 105. Each of the recorders 101 to 103 and TV 104 can exchange data with any of the other devices. The network 105 may be a LAN to be set up in the home of general users or a LAN to be created within the office building of a company. Optionally, the network 105 may also be established over the Internet, for example.

Each of the recorders 101 to 103 can record a content such as a broadcast program or play back the recorded content by itself. For example, the recorder 101 may write content data on a DVD 205 or may read content data that was written on the DVD 205 and present the content on the TV 104 based on that data. The audio is output through loudspeakers (not shown). The recorders 101 and 102 may be DVD recorders, for example, and the recorder 103 may be a PC that has the functions of recording and playing video. Each of the operations described above is started when an infrared instruction signal that has been transmitted from an attached remote controller 106 is received at a receiving section 215 or when a button arranged on the body is pressed to enter an instruction.

Each of these recorders 101 to 103 is uniquely identifiable in the network 105 by its own device information. Examples of the device information include a terminal's name in the network, an identification number (such as a MAC address) assigned to a network interface, and an ID or a serial number given to a CPU or any other hardware component. These pieces of identification information may be combined with each other arbitrarily. In this example, three recorders are illustrated. However, this is just an example, and there may be any other number of recorders as long as the number is at least two.

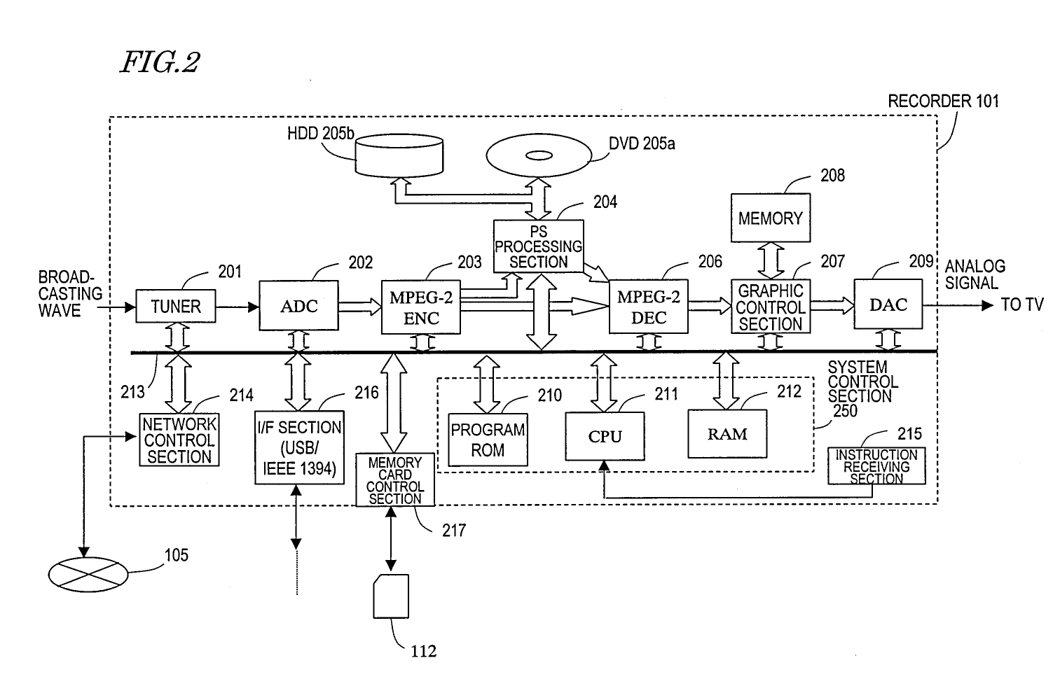

Next, the configuration of the recorder 101 will be described with reference to FIG. 2. The other recorders 102 and 103 may have the same configuration as the recorder 101, and the description thereof will be omitted herein.

FIG. 2 shows an arrangement of functional blocks in the recorder 101. The recorder 101 can write content data not only on a DVD 205a but also on a hard disk 205b as storage media. That is to say, the recorder 101 is a DVD recorder with the built-in HDD 205b.

The recorder 101 includes a tuner 201, an A/D converter 202, an MPEG-2 encoder 203, a PS processing section 204, an MPEG-2 decoder 206, a graphic control section 207, a memory 208, a D/A converter 209, a CPU bus 213, a network control section 214, an instruction receiving section 215, an interface (I/F) section 216, a memory card control section 217 and a system control section 250. In FIG. 2, the optical disk 205a is shown within the recorder 101. However, the optical disk 205a is removable from the optical disk recorder 101 and is not an integral part of the recorder 101 itself.

Hereinafter, the functions of these components will be described one by one.

The tuner 201 receives a broadcasting wave from an antenna (not shown), tunes itself to a particular channel according to the frequency, extracts an analog signal of a requested program, and then outputs the video and audio signals of the program to the A/D converter 202.

The A/D converter 202 converts the input analog signals into digital ones and supplies them to the MPEG-2 encoder 203. On receiving an instruction to start recording, the MPEG-2 encoder 203 (which will be simply referred to herein as an “encoder 203”) compresses and encodes the supplied digital data of the analog broadcast into the MPEG-2 format, generates a program stream and passes it to the PS processing section 204. This processing is continued until the encoder 203 receives an instruction to end the recording. To perform the compression coding, the encoder 203 includes a buffer (not shown) for temporarily storing reference pictures and so on.

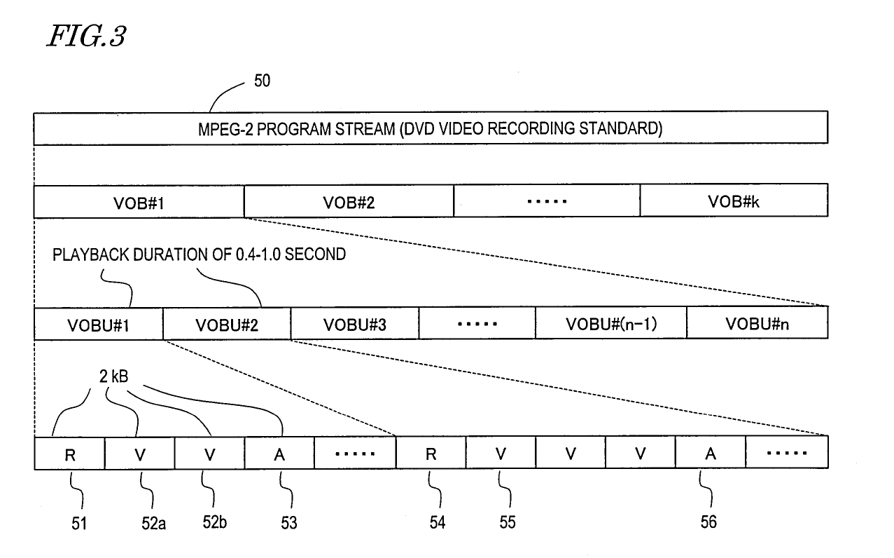

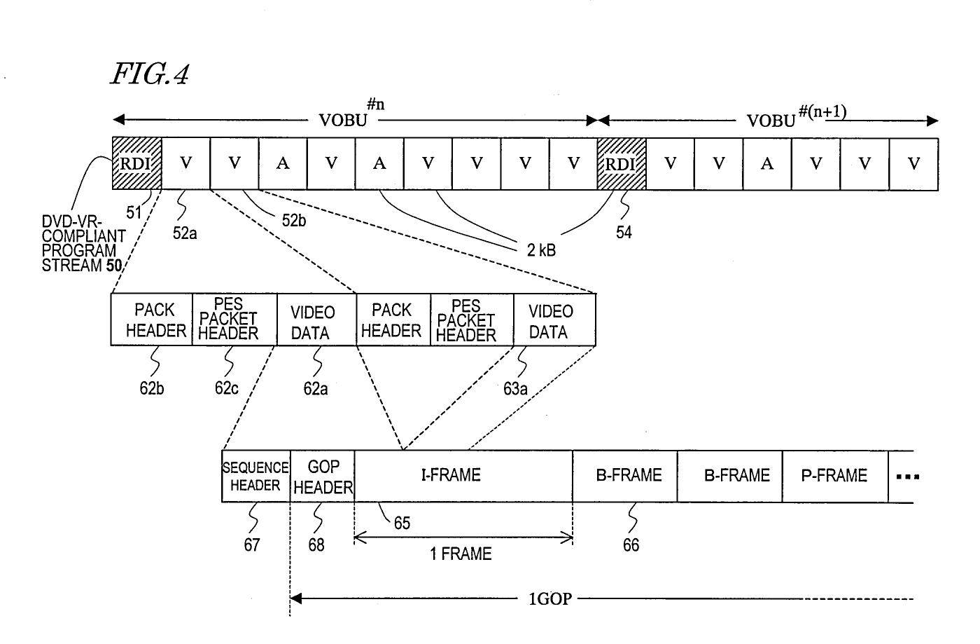

In recording moving pictures, the PS processing section 204 receives MPEG-2 moving picture data, generates a program stream (PS) from it, and writes the stream on the DVD 205a and/or the HDD 205b. The program stream is a data stream, of which the format is suitable for recording it on the DVD 205a and/or the HDD 205b. The program stream will be described more fully later with reference to FIGS. 3 and 4.

When writing a program stream on a storage medium, the PS processing section 204 adds unique identification information to the program stream. This identification information is used to uniquely identify a content on the storage medium and may be the title of a program represented by the program stream. The recording date and time or information about the channel of the recorded program may also be used as other pieces of identification information in addition to, or instead of, the program's title. In this preferred embodiment, the title of a program is used as the identification information. That is to say, mutually different titles are supposed to be given to all contents.

In playing back moving pictures, the PS processing section 204 reads a program stream from the DVD 205a and/or the HDD 205b and outputs it to the MPEG-2 decoder 206.

Also, the PS processing section 204 may receive still picture data that is stored in a memory card 112 from a memory card control section 217 to be described later, write the still picture data on the DVD 205a and/or the HDD 205b, and then read the still picture data written and output it to the decoder 206. In this description, the PS processing section 204 is supposed to write data on the DVD 205a and/or the HDD 205b and read data from at least one of these just for illustrative purposes. Actually, however, the stream is written on, or read from, the DVD 205a or HDD 205b by controllers (not shown) provided for the respective drives as the disk rotates and as the head moves.

The MPEG-2 decoder 206 (which will be simply referred to herein as a “decoder 206”) analyzes the program stream supplied to get MPEG-2 compression-encoded data. Then, the decoder 206 expands the compression-encoded data, converts it into decompressed data and then passes it to the graphic control section 207. The decoder 206 can convert not only the MPEG-2 compression encoded data but also still picture data compliant with the JPEG standard into decompressed data. The graphic control section 207 is connected to the internal computer memory 208 and realizes an on-screen display (OSD) function. For example, the graphic control section 207 combines any of various menu pictures with the video and outputs the resultant synthetic image to the D/A converter 209. In response, the D/A converter 209 converts the input OSD synthetic image and audio data into analog data and outputs them to the TV 104, for example.

The CPU bus 213 is a path for transferring signals in the recorder 201 and is connected to the respective functional blocks as shown in FIG. 2. In addition, the respective components of the system control section 250 to be described later are also connected to the CPU bus 213.

The network control section 214 is an interface for connecting the recorder 101 to the network 105 and is a terminal and a controller that are compliant with the Ethernet™ standard, for example. The network control section 214 exchanges data over the network 105. The data may be the device information and the identification information described above, for example. Furthermore, timetable data about broadcast programs and updated data of a software program for controlling the operation of the recorder 101 may also be exchanged.

The instruction receiving section 215 is a photodetector section for receiving an infrared ray from the operating button arranged on the body of the recorder 101 or from a remote controller. The instruction receiving section 215 receives a user's instruction to start or stop a recording operation or to start or stop playing back a recorded program. Furthermore, the instruction receiving section 215 receives information that designates contents to play back and information that specifies a playback interval from the user while a playlist is being produced. Also, the instruction receiving section 215 further receives an editing instruction on how to edit the content data (such as how to change or delete the playlist). In any case, the instruction receiving section 215 outputs a signal corresponding to the instruction received to the CPU 211. In the example illustrated in FIG. 2, the output signal of the instruction receiving section 215 is directly input to the CPU 211. Alternatively, the output signal of the instruction receiving section 215 may be input to the CPU 211 by way of the CPU bus 213.

The interface (I/F) section 216 controls the connector for use to allow the recorder 101 to communicate with other devices and also controls the communications themselves. The I/F section 216 includes a terminal compliant with the USB 2.0 standard, a terminal compliant with the IEEE 1394 standard, and a controller for enabling data communications according to any of these various standards and can exchange data according to a method that complies with any of these standards. For example, the recorder 101 may be connected to the other recorder 102 or the PC 103 by way of the IEEE 1394 terminal.

The memory card control section 217 includes a slot for loading the memory card 112 into the recorder 101 and a controller for controlling data communications between the recorder 101 and the memory card 112. The memory card control section 217 reads out a still picture data file, a moving picture data file or any other file from the memory card 112 loaded and transmits it over the CPU bus 213.

The system control section 250 controls the overall processing of the recorder 101 including the signal flows there and includes a program ROM 210, a CPU 211 and a RAM 212, all of which are connected to the CPU bus 213. A software program for controlling the recorder 101 is stored in the program ROM 210. The program ROM 210 may be an electrically erasable and programmable ROM (EEPROM).

The CPU 211 is a central processing unit for controlling the overall operation of the recorder 101. By reading and executing a program, the CPU 211 generates a control signal to realize the processing defined by the program and outputs the control signal to the respective components over the CPU bus 213. The memory 212 has a work area for storing data that is needed for the CPU 211 to execute the program. For example, the CPU 211 reads out a program from the program ROM 210 and outputs it to the random access memory (RAM) 212 through the CPU bus 213 and executes the program. The computer program may be circulated on the market by being stored on a storage medium such as a CD-ROM or downloaded over telecommunications lines such as the Internet. As a result, a computer system that is set up using a PC and so on can also operate as a data processor having similar functions to those of the recorder 101 of this preferred embodiment.

Next, the data structure of a program stream to be processed by the recorder 101 will be described.

FIG. 3 shows a data structure for an MPEG2 program stream 50 compliant with the DVD Video Recording standard (which will be referred to herein as the “VR standard”). Such a stream will be referred to herein as a “program stream 50”.

The program stream 50 includes a plurality of video objects (VOBs) #1, #2, . . . , and #k. Supposing the program stream 50 is a recorded content, for example, each VOB stores moving picture data that was generated during a single video recording session (i.e., since the user started recording the video and until he or she stopped doing it).

Each VOB includes a plurality of VOB units (VOBUs) #1, #2, . . . , and #n. Each VOBU is a data unit containing data with a video presentation times of about 0.4 seconds to about 1 second. Hereinafter, the data structure of VOBUs will be described with the first and second video object units taken as an example.

VOBU #1 is composed of a number of packs. In the program stream 50, each pack has a fixed data length (also called a “pack length”) of 2 kilobytes (i.e., 2,048 bytes). At the top of the VOBU, a real time information pack (RDI pack) 51 is positioned as indicated by “R” in FIG. 3. The RDI pack 51 is followed by multiple video packs “V” (including video packs 52a and 52b) and multiple audio packs “A” (including audio pack 53).

Each pack stores the following information. The RDI pack 51 stores various information for controlling the playback of the program stream 50, e.g., information representing the playback timing of the VOBU and information for controlling copying of the program stream 50. The video packs 52a, 52b store MPEG2-compressed video data thereon. The audio packs 53 store audio data that was compressed so as to comply with the MPEG2 Audio standard, for example. In adjacent video and audio packs, video and audio data to be played back synchronously with each other may be stored. However, those packs may be arranged in any order.

VOBU #2 is also made up of a plurality of packs. An RDI pack 54 is placed at the top of VOBU #2, and then followed by a plurality of video packs 55 and a plurality of audio packs 56. The contents of the information to be stored in each of these packs are similar to those of VOBU #1.

FIG. 4 shows the data structure of a video pack in the program stream 50. Hereinafter, the video pack 52a will be taken as an example. The video pack 52a stores MPEG2-compressed video data 62a therein. The video pack 52a further includes a pack header 62b and a PES packet header 62c showing the identity as a video pack. Also, if the video pack 52a is the first one of the VOBU, a system header (not shown) is further included in the pack header 62b.

The video data 62a of the video pack 52a shown in FIG. 4, with the video data 63a and so on of the following video packs 52b, etc., make up the data of an I-frame 65. After the I-frame, video packs making up a B-frame 66 or a P-frame are recorded continuously.

The video data 62a further includes a sequence header 67 and a GOP header 68. The MPEG2 standard defines a “group of pictures (GOP)” as a group of video frames. The GOP header 68 indicates the top of each GOP. The first frame of each GOP is always an I-frame.

Each video frame is given a presentation time stamp (PTS), which shows the time when that frame is read and output. The PTS may be provided for video frames every one-thirtieth second, for example. The time information PTS is represented as a clock counter value (PTS value) and its precision is 1/90 kHz. Also, to synchronize the timings with each other on the transmitting and receiving ends, a clock reference is transmitted, thereby controlling a PLL circuit (not shown). The reference clock may have a frequency of 27 MHz and includes a system clock reference (SCR) for the overall program stream and a program clock reference (PGR) for each program. According to the MPEG-2 standard, the time information PTS is represented in 33 bits and stored in the header (not shown) of each frame data. As for audio frames, the PTS is added to each unit (i.e., each audio frame) consisting of 1,536 samples in total as for the AC-3 audio, for example.

Next, it will be described how to perform a playlist playback operation using a plurality of contents recorded. The following Table 1 shows an exemplary playlist:

TABLE 1

| Title | Start time | End time |
|---|---|---|
| a | TS_1 | TE_1 |
| b | TS_2 | TE_2 |
| c | TS_3 | TE_3 |

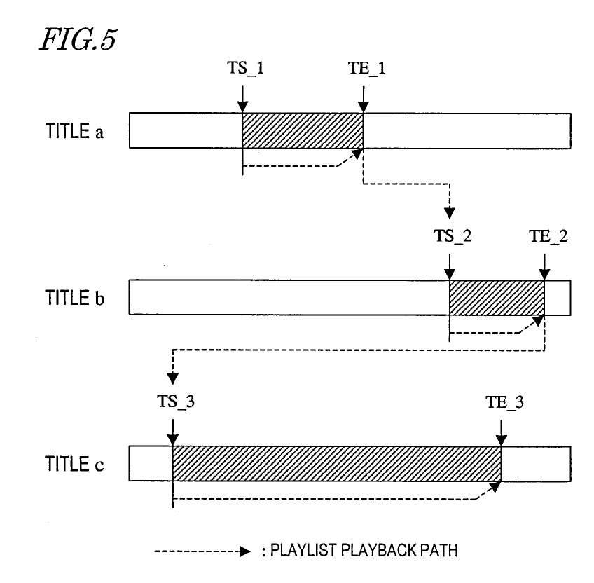

In the playlist, the playback start time and end time are specified on a title-by-title basis. The start and end times are represented as the PTS values mentioned above. FIG. 5 shows the procedure of a playback operation being performed using the playlist shown in Table 1. The recorder 101 may begin the playback operation with the title on the upper column and may sequentially play back the other titles that follow one after another. In that case, the titles a, b and c are played back following the playback procedure shown in FIG. 5. It should be noted that when the titles to present change from one into another, those titles can be presented seamlessly by reading the data of the latter title beforehand.

One of the primary features of the recorder/player system 100 of this preferred embodiment lies in that the system can also handle a situation where the “titles a, b and c” shown in Table 1 are stored on mutually different recorders that are connected to the network 105, not within a single recorder. The following Table 2 shows an exemplary playlist according to this preferred embodiment.

TABLE 2

| | Name of target | | |
|---|---|---|---|
| Title | recorder | Start time | End time |
| a | B | TS_1 | TE_1 |
| b | C | TS_2 | TE_2 |
| c | A | TS_3 | TE_3 |

Comparing this Table 2 with Table 1, it can be seen that a column entitled “Name of target recorder” has been newly added to Table 2 to show on which recorder the data of the title designated as a title to play back on the playlist is stored. This playlist may be made by Recorder B, for example.

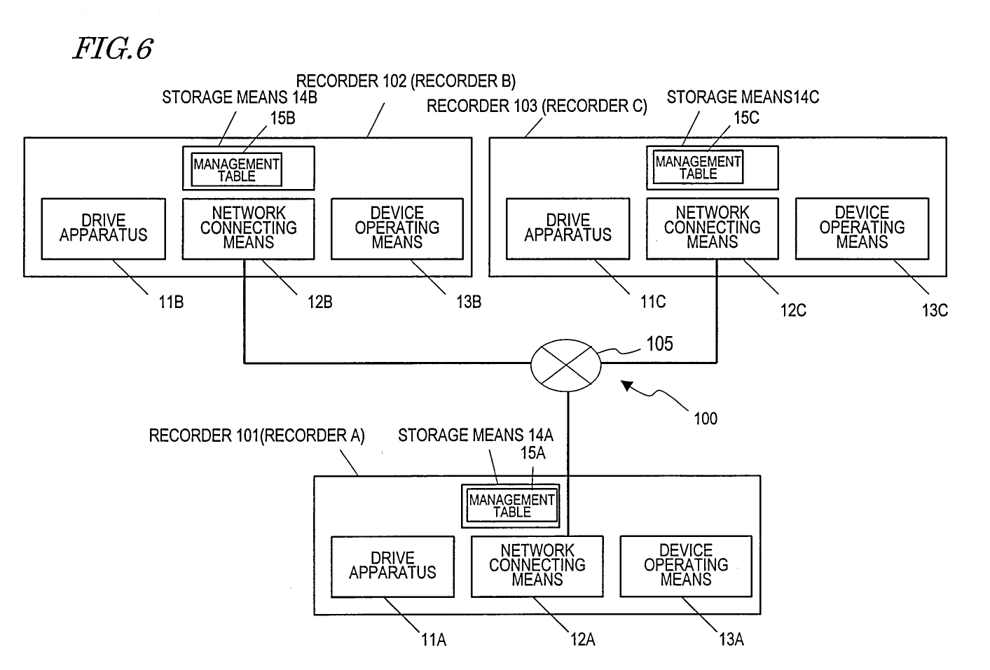

To make the playlist shown in Table 2, the playback ranges cannot be defined unless it is known what contents with what titles are stored on which recorder. Thus, it will be described with reference to FIGS. 6 through 9 what processing should be done by the recorder/player system 100.

First, to make the processing done by each of the recorders 101 to 103 of this preferred embodiment easily understandable, a simplified configuration for the recorders will be described.

FIG. 6 shows a simplified configuration for the recorders 101 to 103. These recorders may have substantially the same configuration. In the following description, the recorders 101, 102 and 103 will be referred to herein as Recorders A, B and C, respectively, for convenience sake, and each component of Recorder A, B or C will be identified herein by a reference numeral with its associated recorder name A, B or C. For example, Recorder A includes a drive apparatus 11A, network connecting means 12A, device operating means 13A and storage means 14A. Likewise, Recorder B also includes a drive apparatus 11B, network connecting means 12B, device operating means 13B and storage means 14B. So does Recorder C.

Recorders A, B and C are connected together via the network 105. Over this network, each of these recorders may exchange information about program contents that is stored on the storage medium of any drive apparatus. The network 105 may be a wired line compliant with the Ethernet® standard, for example, or a wireless line. The network 105 may include a router, a hub and so on.

Each of the drive apparatuses 11A, 11B and 11C collectively refers to a number of kinds of drives that can read and write data from/on various storage media including the DVD-RAM 205a, hard disk 205b, and memory card 112. The PS processing section 204 of each of these recorders A, B and C may instruct its associated drive to record a content on a storage medium or play a recorded content, for example.

Each of the network connecting means 12A, 12B and 12C is a component for communicating with any other recorder/player (e.g., the other recorders) and may refer to the network control section 214, the I/F section 216 or any other component. If the network 105 is an Ethernet®, the network connecting means is equivalent to the network control section 214. On the other hand, if apparatuses are connected to the network 105 by way of a USB cable and a USB hub, then the network connecting means corresponds to the I/F section 216.

Each of the device operating means 13A, 13B and 13C corresponds to the remote controller 106 and operating buttons attached to Recorder A, B or C. Alternatively, the device operating means may also be a component that receives an instruction signal from any other recorder/player and relays the signal to the internal components of each recorder. For example, the device operating means may be either a circuit that outputs the signal to the internal components of the network control section 214 of a recorder or the system control section 250 or the CPU 211 that interprets the received signal.

Each of the storage means 14A, 14B and 14C is a memory that allows Recorder A, B or C to store its own management table 15A, 15B or 15C (to be described later) and corresponds to the RAM 212, buffer (not shown) and/or electrically erasable programmable ROM 210.

The management table 15A, 15B or 15C stored in each of the storage means 14A, 14B and 14C retains the titles of the contents that are stored on each Recorder A, B or C. In addition, the management table 15A, 15B or 15C shows whether or not any of the contents stored in itself is designated as a title to play back according to the playlist that is made and retained by any other recorder and, if the answer is YES, also shows the name of the recorder that designates the content. The management tables 15A, 15B and 15C are updated whenever a playlist is made on any other recorder or any content is deleted. The update is done by the CPU 211.

Portions (a) through (c) of FIG. 7 show how the management table of Recorder A changes. Specifically, portion (a) of FIG. 7 shows a management table 15A-1 indicating that contents with titles A1, A2, A3 and so on are stored on Recorder A. The column “Name of Designator Recorder” is blank. Thus, it can be seen that these titles are not yet referred to by the playlist of any other recorder.

Suppose the user has started making a playlist using Recorder B in the state shown in portion (a) of FIG. 7. In that case, first, the CPU 211 of Recorder B requests the other recorders to send their management tables retained. In response to the request, Recorders A and C send their management tables to Recorder B. Specifically, Recorder A sends the management table shown in portion (a) of FIG. 7 to Recorder B. As a result, Recorder B now knows what contents are stored on the other recorders. Recorder B presents a list of the contents that are described on the management tables acquired to the user on a TV, for example. When the user designates a content to play back and specifies the playback interval of each content by looking through the list, Recorder B sends a notification showing that the content has been designated to the recorder that retains that content thereon.

On receiving that notification, Recorder A updates its own management table. Portion (b) of FIG. 7 shows the management table 15A-2 indicating a situation where a content with the title A1 has been designated as a content to play back on the playlist made on Recorder B.

After that, the playlist will be compiled in a similar manner at Recorder B. Meanwhile, every time a playlist is made at Recorder A or any other recorder, its management table is updated immediately.

When a number of playlists are made, a single content may be referred to on multiple playlists. Portion (c) of FIG. 7 shows a management table 15A-3 on which each content is designated as a content to play back on the playlist of at least one recorder. The names of the designator recorders are all written for every content. In this example, the alphabets A, B and C of Recorders A, B and C shown in FIG. 6 are used as the recorder names. Alternatively, the recorder names may also be the device information described above, for example. On the management table of this Recorder A, the title A1 is designated by Recorder A itself, which means that the user of Recorder A has designated the content, stored on Recorder A, as a content to play back using the playlist.

As described above, each management table is updated by the recorder that retains the management table.

Hereinafter, it will be described in further detail how Recorder A operates in the recorder/player system 100. It should be noted, however, that the operation of Recorder A will be described just by way of example and Recorder B or C operates in the same way, too. In the following example, the user of Recorder B has made a playlist with the content A1 on Recorder A designated as a content to play back.

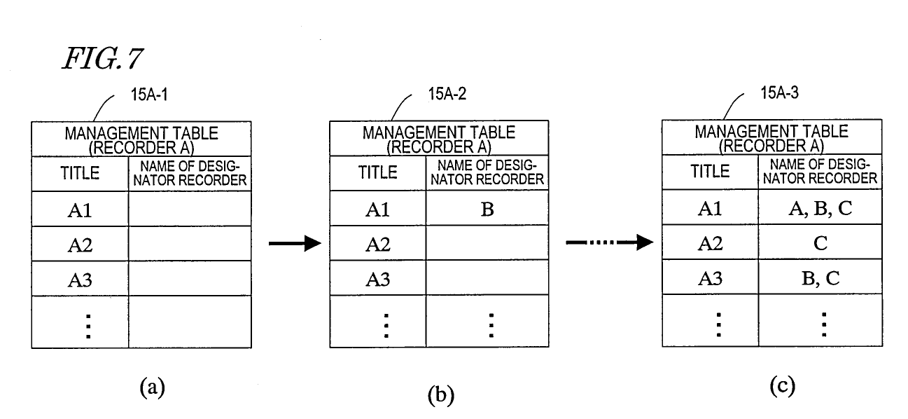

FIG. 8 shows the procedure of processing to be done by Recorder A. In Step S11, in response to the operation done by the user of Recorder B, the range selection of the content A1 is accepted. The range may be selected by specifying the playback start and end times using the PTS about the video data of the content A. Alternatively, the range may also be selected by setting start and end points using chapter start and end points to be inserted at predetermined intervals. Optionally, the start and end points may be set such that the range will cover multiple contents. As another alternative, the contents themselves may be simply entered into the list by using their start and end times.

In Step S12, a query is sent to the user of Recorder B, thereby prompting him or her to send an instruction on whether he or she still needs to select another range or wants to finish the range selection operation right now. If he or she needs to select another range, the process goes back to the previous processing step S11. On the other hand, if he or she wants to finish, then the process advances to Step S13.

In Step S13, the CPU 211 of Recorder A updates the information about the ranges that have been selected so far on the management table. Meanwhile, the playlist is saved at Recorder B. Consequently, the management table is updated into the management table 15A-2 shown in portion (b) of FIG. 7. As a result of these processing steps, the management table 15A-2 is obtained.

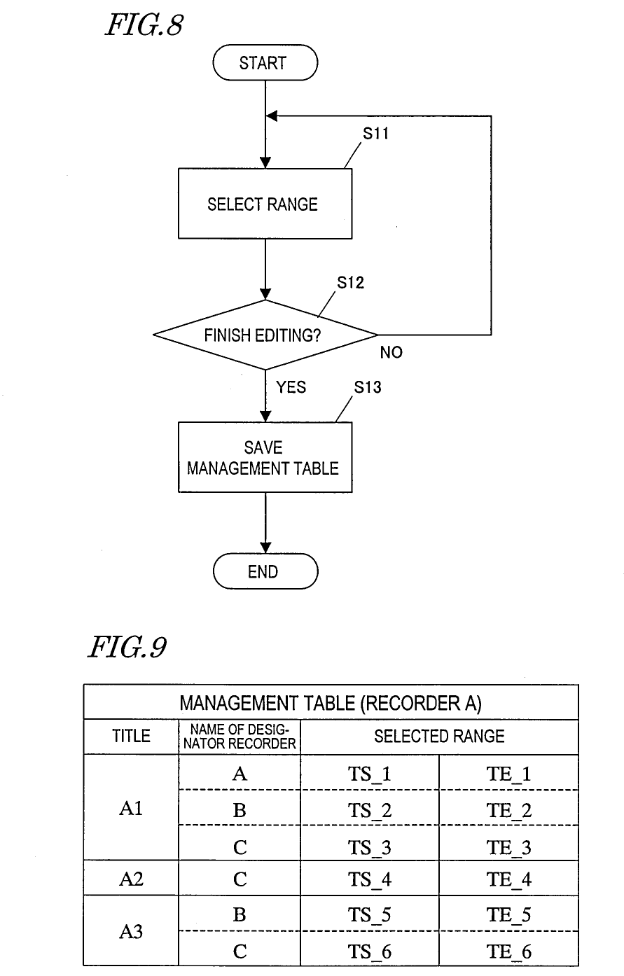

In this example, only the names of the designator recorders are supposed to be written on the management tables 15A-2 and 15A-3 described above (see portions (b) and (c) of FIG. 7). However, the data structure of the management table is not defined by only the designator recorder name. For example, FIG. 9 shows a management table for Recorder A on which the name of a designator recorder is associated with the selected range on a playlist. Each title may be designated as a content to play back on the playlist(s) of one or more recorders. When a title is designated, the start time information TS_n and end time information TE_n of the selected range are stored on each and every recorder.

For example, Recorder C designates all three titles A1, A2 and A3. The selected range of the title A1 lasts from the time TS_3 through the time TE_3.

In response to the operation, the title A1 is designated by Recorder A itself and TS_1 and TE_1 are set as its start and end points, respectively. The title A1 is also designated by Recorders B and C and their start and end times are TS_2, TE_2 and TS_3, TE_3, respectively. Likewise, the title A2 is also designated by Recorder C and its start and end points are set at TS_4 and TE_4, respectively.

By reference to the management table shown in FIG. 9, data that are separately present on multiple recorders can be played back because the playlist information includes information to identify the devices. The information to identify the devices may be the devices' own IDs, their addresses on the network to which the devices are connected by way of the communication means 4, or any other piece of information contributing to identifying the devices.

By updating the management tables following the processing procedure described above, a playlist that defines a playback path including contents on multiple recorders can be compiled easily.

### Embodiment 2

The functions of a recorder to be realized by using the management table as described for the first preferred embodiment will be described as a second specific preferred embodiment of the present invention.

According to the first preferred embodiment of the present invention described above, each of multiple recorders that are connected together via the network 105 can designate, on a playlist, not only a content stored in itself but also a content stored on any other recorder as contents to play back. It has also been described that multiple playlists compiled by a number of recorders may include the same content as a content to play back.

In general, a user can not only make a playlist but also edit the content data itself as he or she likes. That is why if requests to edit the same content, received from multiple recorders, were accepted, then the content could not be played back just as intended on the playlists of the recorders. This is because the content data could be deleted or changed as a result of the editing operation from another recorder. That is to say, there might be an inconsistency in the content data.

In view of this potential situation, according to this preferred embodiment, when the same content is designated on multiple playlists as a content to play back, access is controlled so as to prevent multiple recorders from editing that content at the same time.

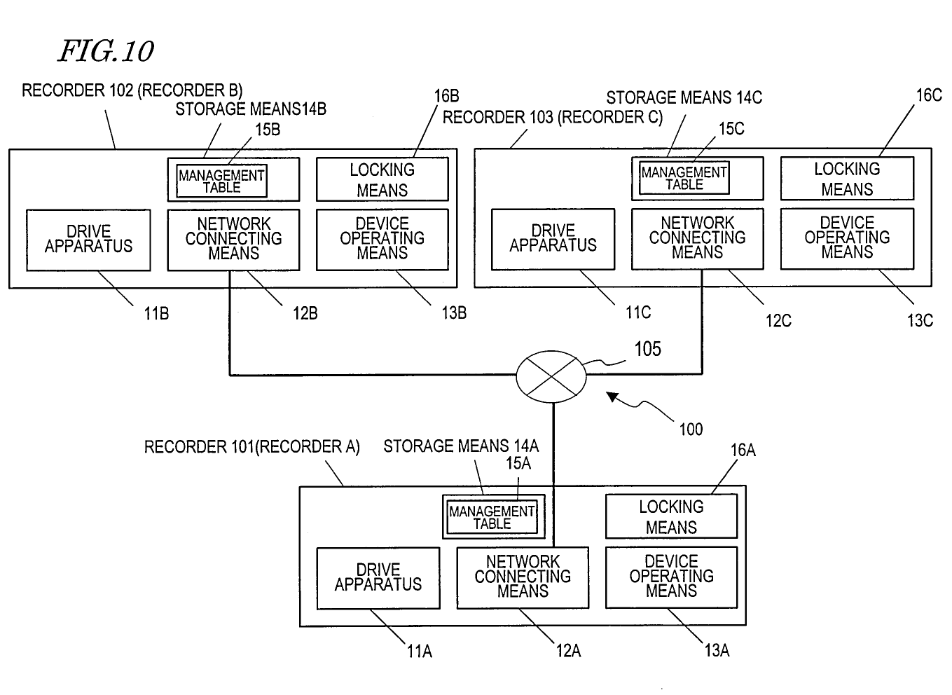

FIG. 10 shows a configuration for a recorder/player system 100 according to a second specific preferred embodiment of the present invention. Each recorder of this system includes locking means. Specifically, the recorders 101, 102 and 103 include locking means 16A, 16B and 16C, respectively. In the other respects, the configuration shown in FIG. 10 is the same as that of the first preferred embodiment shown in FIG. 6. Thus, the function of the locking means will be described first, and then the processing to be done by the recorders by taking advantage of that function will be described. In the following description of the second preferred embodiment, the recorders 101, 102 and 103 will also be referred to as Recorders A, B and C for convenience sake.

Each of the locking means 16A, 16B and 16C prohibits editing (e.g., modifying or deleting) a content that is stored on Recorder A, B or C. More specifically, the locking means of a recorder sends a lock setting request to prohibit editing a particular content to the locking means of the other recorders. Also, the locking means receives the lock setting request from another locking means and locks the designated content. The lock can be set by putting up a flag with a predetermined value on a lock setting field of the management table. The information defined on the lock setting field will sometimes be referred to herein as “lock setting information”. The locking means may also unlock a content.

The functions of the locking means 16A, 16B and 16C are realized by the system control section 250. That is to say, the CPU in the system control section 250 reads a computer program, which makes processing(s) done according to the flowchart to be described later, from the program ROM 210 and executes it on the RAM 212, thereby performing the processing that prohibits editing a particular content.

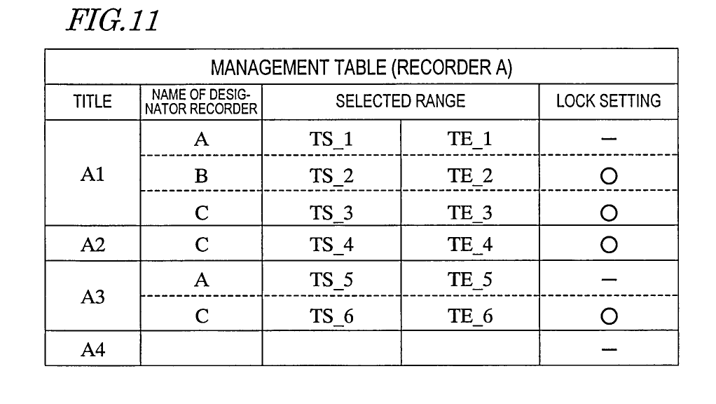

FIG. 11 shows an exemplary management table according to this preferred embodiment. This management table is generated by the CPU 211 and stored on the storage means 14A. The CPU 211 changes the lock setting information of a given content, which has been designated by the locking means of another recorder as the target of lock setting among the contents (i.e., titles A1 through A4) stored on Recorder A, into “locked”. The content to be locked is a content designated as a content to play back on the playlist of another recorder. In FIG. 11, the lock setting information in the “locked” state is indicated by the open circle O. On the playlist of Recorder A, a content on Recorder A itself may be designated. In that case, the “locked state” is not set according to this preferred embodiment. However, this method is just an example. Alternatively, the locking means 16A of Recorder A may output the lock setting request to itself and set the “locked state” in response to that request.

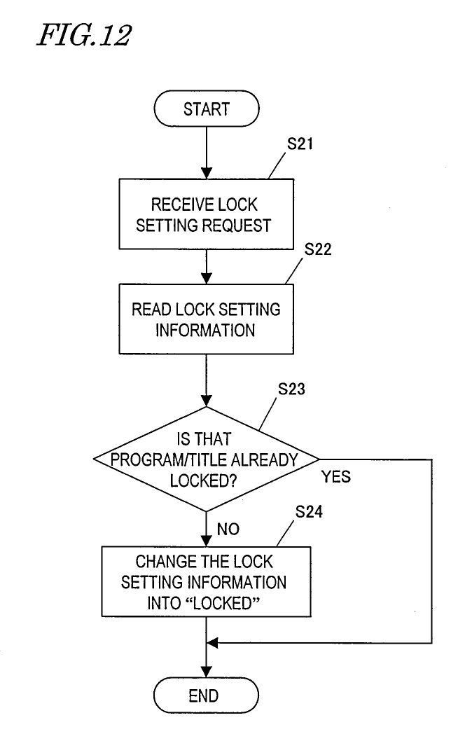

Hereinafter, it will be described with reference to FIGS. 12 to 15 how the locking means operates.

FIG. 12 shows how the locking means performs the lock setting processing. First, in Step S21, the locking means receives a lock setting request from the locking means of another recorder. Any recorder on the network may send this request. When the request is received, the device information (device ID) to identify the recorder that has sent the request and the identification information (program ID) to identify the content to be locked are also received.

Next, in Step S22, the locking means reads the lock setting information of that content from the management table by reference to the program ID. Subsequently, in Step S23, the locking means determines whether or not the content to be locked has already been locked. If the answer is NO, the process advances to Step S24. On the other hand, if the answer is YES, the processing ends.

In Step S24, information about the recorder that has sent the request is written on the device ID of the content to be locked and information showing that the lock should be set is written on the lock/unlock flag (i.e., the flag is put up) to end the processing.

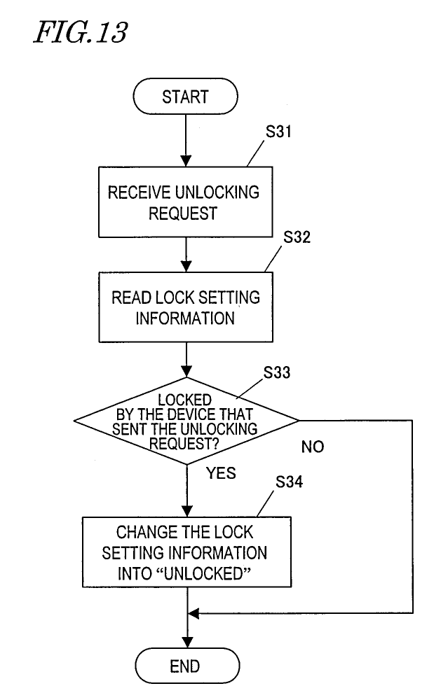

Hereinafter, it will be described how the locking means operates to unlock a given content. FIG. 13 shows the procedure of unlocking processing to be done by the locking means.

First, in Step S31, the locking means receives an unlocking request. Any recorder on the network may send this request. When the request is received, the device information (device ID) to identify the recorder that has sent the request and the identification information (program ID) to identify the content to be locked are also received.

Next, in Step S32, the locking means reads the lock setting information of that content from the management table by reference to the program ID.

Subsequently, in Step S33, the locking means compares the device ID in the management information with that of the recorder/player that has sent the unlocking request, thereby determining whether or not these IDs agree with each other. If the answer is YES, the process advances to Step S34. Otherwise, the process ends.

Finally, in Step S34, the lock setting information of the designated content is rewritten into “unlocked state”.

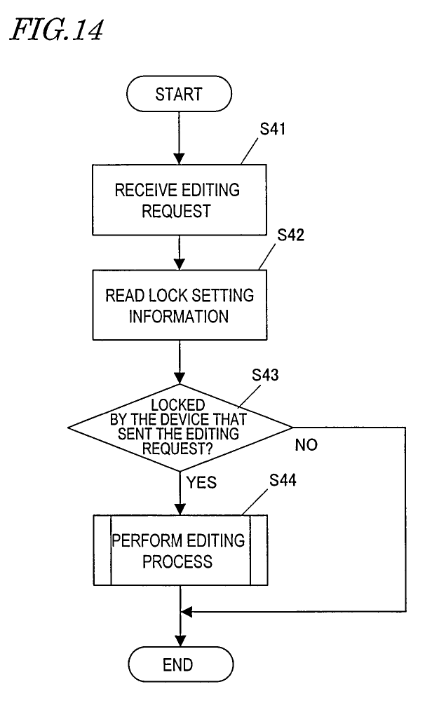

Hereinafter, it will be described how the locking means works during a content editing operation according to this preferred embodiment. In the following description of this preferred embodiment, the “editing” operation is supposed to be a content deleting process. However, this is just an example. As used herein, “editing” means any type of general processing that changes the original content data in one way or another. FIG. 14 shows the procedure of processing to be done by the locking means during the editing operation.

First, in Step S41, the locking means receives an editing request from another recorder. Any recorder on the network may send this request. When the editing request is received, the device information (device ID) to identify the recorder/player that has sent the request and the identification information (program ID) to identify the content to be edited are also received.

Next, in Step S42, the locking means reads the lock setting information of that content from the management table by reference to the program ID.

Subsequently, in Step S43, the locking means compares the device ID of the recorder that has sent the editing request with that included in the management information, thereby determining whether or not these IDs agree with each other. If the answer is YES, the process advances to Step S44. Otherwise, the process ends.

Next, in Step S44, the system control section 250 carries out an editing process.

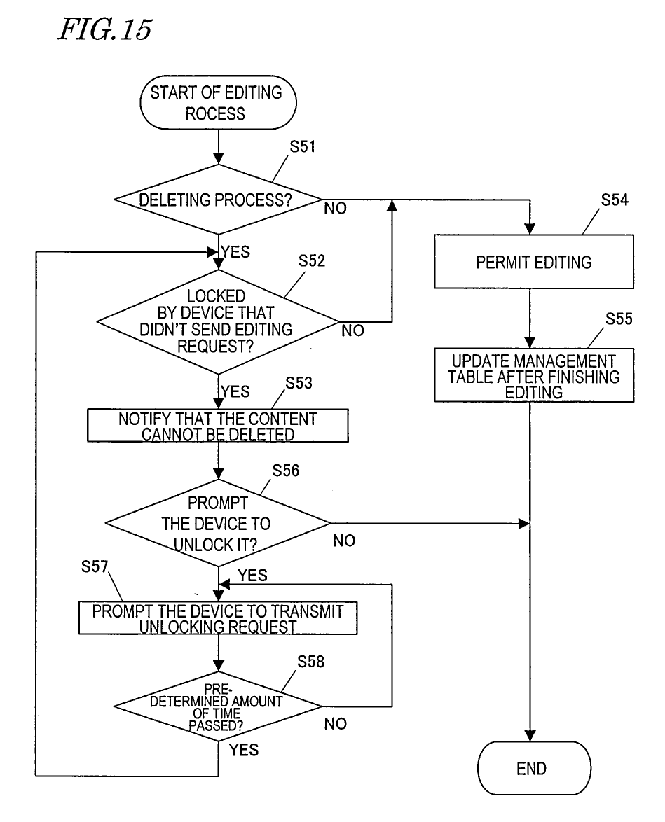

FIG. 15 shows the detailed procedure of the editing process. First, in Step S51, the locking means determines whether or not the editing process requested is a content deleting process. If the answer is YES, the process advances to Step S52. Otherwise, the process advances to Step S54.

In Step S52, the locking means determines, by the lock setting information, whether or not a device other than the device that has sent the editing request is locking that content. In the example shown in FIG. 11, for instance, the content with the title A1 is locked by the other Recorders B and C but the content with the title A4 is not locked for Recorder A. If the content is being locked, the process advances to Step S53. Otherwise, the process advances to Step S54.

In Step S53, the locking means notifies the recorder that has sent the editing request that the content cannot be deleted. This is because if the deletion were permitted, then the playback operations to be performed following the playlists made by the other devices would be inconsistent. After the notification, the process advances to Step S56.

Meanwhile, in Step S54, the lock setting means permits the content data editing. Next, in Step S55, when the editing operation finishes by deleting the content data, the CPU 211 in Recorder A updates the management table. More specifically, the CPU 211 deletes the content entry from the management table.

In Step S56, the locking means determines whether or not to prompt the recorder that sent the lock setting request to unlock it. This decision may be made either in response to the user's instruction or based on predetermined settings. If the answer is YES, the process advances to Step S57. Otherwise, the process ends.

In Step S57, the locking means prompts the recorder that sent the lock setting request to transmit an unlocking request. Next, in Step S58, the locking means asks for the transmission continuously until a predetermined amount of time passes. When the unlocking request is received in response to this prompt from the recorder that sent the lock setting request, the unlocking process shown in FIG. 13 is carried out. After that, the process goes back to Step S52 to perform the same processing steps S52 and so on all over again.

By performing these processing steps, editing on the content that is designated as a content to play back on the playlists of multiple recorders is controllable. It should be noted that while a non-locked content is being edited on a recorder, another recorder might issue an editing request on the same content. The content could become inconsistent in that situation, too. That is why if a non-locked content should be edited on a recorder, the recorder that is going to do the editing may issue a lock setting request to itself and make the lock setting by itself. As a result, even if the editing request is sent by the other recorder following the procedure shown in FIG. 15 after the recorder holding the content started editing it, the editing request is denied, thus avoiding the inconsistency that could be caused if the same program were edited by multiple recorders simultaneously.

The lock setting request may be transmitted at other times as well. For example, when a recorder is selected to do playlist editing, the lock setting may be done on every content on that recorder. Alternatively, the lock setting may also be done when an editing screen is presented to the user who is going to do playlist editing after having selected a recorder. The lock setting may even be done not just during the playlist editing but also while a content on another recorder is being dubbed or played back.

On the other hand, the lock setting may be removed either no user's instructions were input for a predetermined amount of time or more after the playlist editing screen was presented (i.e., in case of “time out”) or when the cable for use to connect the recorder to the network 105 is disconnected.

In the foregoing description, the storage medium is supposed to be a DVD. However, this is nothing but an example. Alternatively, the present invention is also applicable for use in any other storage medium such as a Blu-ray disc. When content data is written on a Blu-ray disc, the data may be written in the form of an MPEG-2 transport stream, not a program stream.

### INDUSTRIAL APPLICABILITY

A recorder/player system according to the present invention can make playlist editing more easily on multiple contents that are saved separately on a number of recorders/players. Besides, editing that might be done by multiple recorders/players on the same content simultaneously can be controlled. Consequently, no inconsistency should be caused when any content on a recorder/player is played back on another recorder/player.

1. A data processor capable of exchanging data with a device that is connected to a network, the device being uniquely identifiable in the network by its own device information, the processor comprising:
a content processing section for generating content data about at least one content and identification information to uniquely identify the at least one content and getting the content data and the identification information stored on a storage medium;
a network control section for establishing a connection with the network and sending out the device information and the identification information in response to a request from the device;
a processing section for generating a management table, in which if the at least one content has been designated by the device as a content to play back, the identification information of the at least one content is associated with the device information of the device; and
a storage section for storing the management table.

2. The data processor of claim 1, wherein the processing section generates the management table by further associating interval information, which specifies a playback interval of the at least one content, with the content.

3. The data processor of claim 2, wherein the processing section specifies the playback interval based on the presentation times of the at least one content.

4. The data processor of claim 1, wherein the at least one content includes a plurality of contents, and
wherein the processing section generates the management table by getting the identification information of a non-designated content, which is not designated as a content to play back among the contents, included on the management table and by further associating information showing identity as a content to play back with the identification information of the at least one content that is designated as the content to play back.

5. The data processor of claim 4, wherein two or more devices are connected to the network, and
wherein the network control section receives an editing instruction on how to edit the content data and identification information to identify a content to be edited from a predetermined one of the devices, and
wherein the processing section permits the content data editing if the processing section has determined based on the identification information received and the device information of the predetermined device that the content to be edited is designated as a content to be played only by the predetermined device.

6. The data processor of claim 5, wherein the network control section receives an editing instruction to delete the content data, and
wherein the processing section permits the content data deleting if the processing section has determined that the content to be edited is designated as the content to be played only by the predetermined device.

7. The data processor of claim 6, wherein the processing section deletes the content data and removes the identification information about the deleted content data from the management table.

8. The data processor of claim 5, wherein the processing section prohibits the content data editing if the processing section has determined that the content to be edited is designated as a content to be played back by a device other than the predetermined device.

9. The data processor of claim 8, wherein the network control section outputs a request to remove the content to be edited from the list of contents to play back to the device other than the predetermined device.

10. A data processing method to be carried out by a data processor capable of exchanging data with a device that is connected to a network, the device being uniquely identifiable in the network by its own device information, the method comprising the steps of:
generating content data about at least one content and identification information to uniquely identify the at least one content;
getting the content data and the identification information stored on a storage medium;
establishing a connection with the network and sending out the device information and the identification information in response to a request from the device;
receiving a request, which designates the at least one content as a content to play back, from the device; and
generating a management table on which the identification information of the at least one content is associated with the device information of the device.
